(19) United States
(12) Patent Application Publication
(10) Pub. No.: US 2012/0195606 A1
(43) Pub. Date: Aug. 2, 2012

(54) IMAGE FORMING APPARATUS

(75) Inventors: Satoshi MIYAJIMA, Tokyo (JP); Toru KASAMATSU, Tokyo (JP); Eiji NISHIKAWA, Tokyo (JP); Tadayuki UEDA, Tokyo (JP); Yoshihito SASAMOTO, Tokyo (JP)

(73) Assignee: KONICA MINOLTA BUSINESS TECHNOLOGIES, INC., Tokyo (JP)

(21) Appl. No.: 13/350,936

(22) Filed: Jan. 16, 2012

(30) Foreign Application Priority Data
Jan. 28, 2011 (JP) 2011-016006

(51) Int. Cl. G03G 15/20

(52) U.S. Cl. 399/33; 399/67; 399/68

(57) ABSTRACT

Damages on fixing members caused by paper passing through can be reduced. The registration rollers 53 and the registration oscillation roller 54 are provided on an upstream side of a fixing nip portion in a conveyance path for paper P and have a function of moving the paper P being conveyed toward the fixing nip portion, in a paper width direction, and the control section 10 performs paper oscillation control and fixing unit oscillation control in correlation with each other, the paper oscillation control in which the registration rollers 53 and the registration oscillation roller 54 are controlled to oscillate a position on which the paper P passes through, and the fixing unit oscillation control in which the fixing unit oscillation motor 36 is controlled to oscillate the fixing unit.

This application is based on Japanese Patent Application No. 2011-016006 filed on Jan. 28, 2011, in Japanese Patent Office, the entire content of which is hereby incorporated by reference.

### TECHNICAL FIELD

The present invention relates to image forming apparatuses.

### BACKGROUND

Conventionally, image forming apparatuses are known as, for example, printers and copying machines using the electrophotographic method. The image forming apparatus of this type performs, in order to form a toner image on paper, a process in which a toner image is transferred to the paper and then the toner image is fixed on the paper by passing the paper through a pressing portion (fixing nip portion) of a pair of fixing members constituting a fixing device.

For example, Japanese Laid-Open Patent Application Publication No. 2003-263090 discloses an image forming apparatus in which damages on a fixing member are controlled and whereby an exchange of fixing members having been used for only a short time is controlled by avoiding paper edges from passing through the same position of the fixing member. This image forming apparatus has movable members for controlling and positioning the edge parallel to a conveyance direction of the paper being conveyed on a conveyance path, oscillates the conveyance position of the paper by the movable members, and varies a writing position of an image in an image forming section with respect to the position of the movable members, in other words, with respect to the position of the paper being conveyed to an image forming section. This arrangement varies the passing position of the paper edges and thereby reducing the concentration of the passing position on the same position.

In addition, known is a method in which measures are taken such that the passing positions of the paper edges are varied by periodically oscillating the fixing device.

However, in the case that the fixing device is oscillated, the range of the oscillation width is restricted by the chassis size of the image forming apparatus housing the fixing device. Further, when the writing position of an image is moved to the edge side, in other words, is largely apart from a central position in the paper width direction, the shape of the laser light for exposure use is deformed to be elliptical, whereby the image quality is deteriorated. To avoid this problem the range of the oscillation width of paper is restricted similarly to the case of the oscillation of the fixing device.

### SUMMARY

To achieve at least one of the above-mentioned objects, an image forming apparatus reflecting one aspect of the present invention comprises:

a fixing unit which has a pair of fixing members pressed against each other to form a fixing nip portion therebetween and is configured to fix an image on paper by passing the paper through the fixing nip portion;

a fixing unit drive section configured to move the fixing unit in a paper width direction which is perpendicular to a conveyance direction of the paper;

a conveyance position setting section which is provided in a paper conveyance path on an upstream side, in the conveyance direction of the paper, of the fixing nip portion and which is configured to move the paper being conveyed toward the fixing nip portion, in the paper width direction; and

a control section configured to perform a paper oscillation control and a fixing unit oscillation control in correlation with each other, the paper oscillation control in which a position of the paper being conveyed is oscillated in the paper width direction by controlling the conveyance position setting section, and the fixing unit oscillation control in which the fixing unit is oscillated in the paper width direction by controlling the fixing unit drive section.

In the above-mentioned image forming apparatus, it is preferable that the control section controls the paper oscillation control and the fixing unit oscillation control in correlation with each other so as to enlarge passing ranges in the paper width direction, the ranges which are on the fixing members and in which edges, in the paper width direction, of the paper pass through.

In the above-mentioned image forming apparatus, it is preferable that the control section controls such that an amount of the oscillation by the paper oscillation control and an amount of oscillation by the fixing unit oscillation control are varied depending on a size of the paper.

In the above-mentioned image fanning apparatus, it is preferable that the image forming apparatus comprises:

a temperature detection section configured to detect surface temperature of the fixing member,

wherein when the control section have determined based on a detection result of the temperature detection section that an abnormal temperature region has been generated on the fixing member, the control section interrupts the control in which the paper oscillation control and the fixing unit oscillation control are in correlation with each other, and controls the conveyance position setting section so as to move the paper toward the abnormal temperature region.

To achieve at least one of the above-mentioned objects, an image forming apparatus reflecting one aspect of the present invention comprises:

a fixing unit, the fixing unit having:
a pair of fixing members pressed against each other to form a fixing nip portion therebetween; and
a heating section configured to heat the fixing members,
wherein the fixing unit fixes an image on paper by passing the paper through the fixing nip portion;

a fixing unit drive section configured to move the fixing unit in a paper width direction which is perpendicular to a conveyance direction of the paper;

a conveyance position setting section which is provided in a paper conveyance path on an upstream side, in the conveyance direction of the paper, of the fixing nip portion and which is configured to move the paper being conveyed toward the fixing nip portion, in the paper width direction;

a temperature detection section configured to detect surface temperature of the fixing member, and
a control section configured, when the control section has determined based on a detection result of the temperature detection section that an abnormal temperature region has been generated on the fixing member, to control the conveyance position setting section so as to move the paper toward the abnormal temperature region.

In the first invention, it is preferable that the control section performs paper oscillation control and fixing unit oscillation control in correlation with each other so that the passing range, in the paper width direction, the ranges which are on the fixing members and in which the edges, in the paper width direction, of the paper pass through, are enlarged.

Further, in the first invention, it is preferable that the control section performs the paper oscillation control and the fixing unit oscillation control in correlation with each other so that the spatial nonuniformity and the temporal nonuniformity of the passing through tracks which are on the fixing members and on which the edges, ins the paper width direction, of the paper pass through.

Further, in the first invention, it is preferable that the control section controls the oscillation direction of the paper-conveying member and the oscillation direction of the fixing unit in opposite directions to each other while the center of oscillation of paper and the center of oscillation of the fixing unit in coincidence with each other.

In addition, in the first invention, it is preferable that the control section controls such that the amount of oscillation by the paper oscillation control and the amount of oscillation by the fixing unit oscillation control are varied depending on the size of the paper.

Further, the first invention can further have a temperature detection section to detect the surface temperature of the fixing member. In this case, it is preferable that the control section controls such that when the control section has determined, based on a detection result of the temperature detection section, that an abnormal temperature region has been generated on the fixing member, the control section interrupts the control in which the paper oscillation control and the fixing unit oscillation control in correlation with each other, and moves the paper to an abnormal temperature region by the paper oscillation control.

### BRIEF DESCRIPTION OF THE DRAWINGS

FIG. 1 is a first configuration diagram schematically showing an image forming apparatus 1 according to a first embodiment;

FIG. 2 is a block diagram schematically showing a control system of the image forming apparatus;

FIGS. 3a and 3b are explanatory diagrams of paper oscillation and fixing unit oscillation; FIG. 4 is a flow chart showing an image forming operation of the image forming apparatus 1 according to the first embodiment;

FIGS. 5a and 5b are explanatory diagrams showing a specific example as a method for correlating the paper oscillation control and the fixing unit oscillation control with each other;

FIG. 6 is an explanatory diagram for showing another specific example as the method for correlating the paper oscillation control and the fixing unit oscillation control with each other,

FIGS. 7a and 7b are explanatory diagrams describing the difference in the amount of oscillation depending on sizes of paper P;

FIG. 8 is an explanatory diagram describing an control concept of the image forming apparatus 1 according to the second embodiment; and

FIGS. 9a, 9b, and 9c are explanatory diagrams describing a control concept of the image forming apparatus 1 according to a third embodiment

### DETAILED DESCRIPTION OF HE PREFERRED EMBODIMENT

### First Embodiment

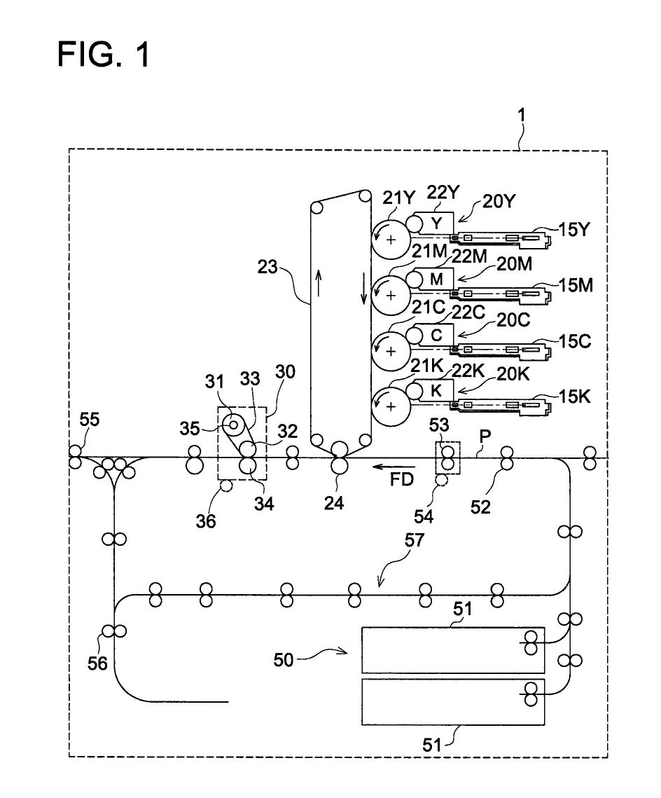

FIG. 1 is a configuration diagram schematically showing the image forming apparatus 1 according to the first embodiment The image forming apparatus 1 is an image forming apparatus such as a copying machine using an electrophotographic method and is so called a tandem color image forming apparatus in which a plurality of photoreceptors are vertically arranged facing one intermediate transfer belt to form full color images.

The image forming apparatus 1 is made up mainly of a document reading device not shown in the drawing, exposure sections 15Y, 15M, 15C, and 15K, charging and developing units 20Y, 20M, 20C, and 20K, an intermediate transfer belt 23, and a fixing device 30, which are housed in a chassis.

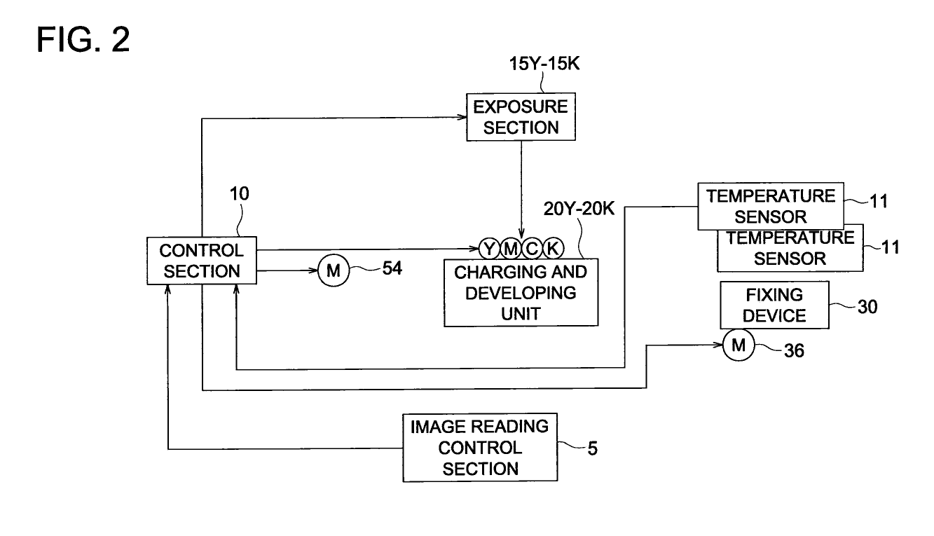

The document reading device has an automatic document feeding device (not shown in the drawing) mounted on the top of the apparatus and reads the image on the document being conveyed by the automatic document feeding device to obtain an image signal. Specifically, the document reading device illuminates the document with a lamp and forms an image of the reflected light on the light receiving surface of an image sensor. The image sensor photoelectrically conversions the incident light and outputs a predetermined image signal to an image reading control section 5 (see FIG. 2). The image reading control section 5 performs the image signal A/D conversion, shading correction, and compression and the like, and outputs the signal as an image data to a control section 10 (see FIG. 2). However, the image data to be input to the control section 10 is not restricted to the signal read by the document reading device, but may be the signal received from a personal computer connected to the image forming apparatus or from other image forming apparatus, for example.

Each of exposure sections 15Y-15K is made up of a laser light source, a polygon mirror, a plurality of lenses and the like. The exposure sections 15Y-15K scan-expose with laser beams the surfaces of photoreceptor drams 21Y, 21M, 21C, 21K to be described later, depending on the output information output from the control section 60 based on the image data.

The charging and developing unit 20Y is constituted mainly by the photoreceptor dram 21Y and a charging and developing section 22Y arranged in its periphery, and forms a toner image corresponding to yellow on the photoreceptor dram 21Y. Similarly, the other charging and developing units 20M, 20C, and 20K are constituted similarly to the charging and developing unit 20Y, charging and developing sections 22M, 22C, and 22K are arranged in the periphery of the photoreceptor drain 21M, 21C, and 21K, respectively, and form toner images corresponding to magenta, cyan, and black on the photoreceptor dram 21M, 21C, and 21K, respectively.

The surfaces of the photoreceptor drams 21Y-21K are uniformly charged by the charging and developing sections 22Y-22K, and a latent images will be formed on each of the photoreceptor drams 21Y-21K through a scan-exposure performed by each of the exposure sections 15Y-15K. The charging and developing sections 22Y-22K are then subjected to development using toner, whereby the latent images on the photoreceptor drams 21Y-21K are made visible. This process forms a toner image on each of the photoreceptor drams 21Y-21K. The toner image formed on each of the photoreceptor drams 21Y-21K is sequentially transferred at a predetermined position on the intermediate transfer belt 23

The toner image of each color having been transferred on the intermediate transfer belt 23 is transferred by a transfer roller 24 onto paper P conveyed at a predetermined time.

A paper supply section 50 is constituted by one or more than one paper supply tray 51, and each paper supply tray 51 stores paper P. The paper supply section 50 feeds the paper P selected by the user from the paper supply tray 51, one by one.

The paper P fed from the paper supply tray 51 is conveyed on the conveyance roller including loop rollers 52 and registration rollers 53 and is fed to the position at which the toner image is transferred onto the paper P by the transfer rollers 24. Specifically, the paper P fed from the sheet supply tray 51 passes through the loop rollers 52 and hits the stationary registration rollers 53, and is then conveyed further on the loop rollers 52 for a predetermined time period so as to be warped to correct the warp of the paper P. Then, a paper-to-paper basis movement associated with the later described paper oscillation control is performed, and the registration rollers 53 then starts rotating at a predetermined time to eject the paper P to the downstream side.

The conveyance roller such as the loop rollers 52 and the registration rollers 53 are rotated by drive motors (not shown in the drawing) controlled by the control section 10 at a predetermined time and a predetermined speed. Further, in the present embodiment, the registration rollers 53 are configured to be able to move in the direction perpendicular to the paper width direction (the direction perpendicular to the paper conveyance direction FD on the surface of the paper P) by a registration oscillation motor 54.

The above-described components, that is to say, the exposure sections 15Y-15K, the charging and developing units 20Y-20K, the intermediate transfer belt 23, and the transfer rollers 24 constitute the image forming unit. That is, the image forming unit transfers the toner image onto the paper P through the series of steps: (1) charging the photoreceptor drains 21Y-21K; (2) forming the electrostatic latent images on the photoreceptor drams 21Y-21K by the exposure sections 15Y-15K; (3) attaching toner to the formed electrostatic latent images; (4) primarily transferring the toner images on the photoreceptor drams 21Y-21K onto the intermediate transfer belt 23; and (5) secondarily transferring the toner images on the intermediate transfer belt 23 onto the paper P by the transfer roller. The paper P having the transferred toner image, that is, the unfixed toner image on a fixing target surface thereon is conveyed to the fixing device 30.

The fixing device 30 is a device to fix the unfixed toner image on the paper P, and is constituted by a fixing upper-roller 31, a pressurizing roller 32, a fixing belt 33, and a fixing lower-roller 34, for example. The fixing upper-roller 31 and the pressurizing roller 32 are arranged with a predetermined distance between them, and a fixing belt 33 is extended between the rollers 31 and 32. The fixing lower-roller 34 is disposed being pressed against the pressurizing roller 32 via the fixing belt 33, and a fixing nip portion is formed at a pressure contact portion between the fixing belt 33 and the fixing lower-roller 34. In this arrangement, the fixing belt 33 is positioned above the paper surface, and the fixing lower-roller 34 is positioned below the paper surface when the paper P passes through the fixing nip portion.

In the fixing upper-roller 31, there is provided a heating section for heating the fixing belt 33, that is, a heater 35 as the heating section for thermally fixing the toner image on the paper P. The fixing upper-roller 31 is heated by the radiation heat from the heater 35, and the heat of the fixing upper-roller 31 is conducted to the fixing belt 3.

The fixing device 30 according to the embodiment is configured to be able to move the fixing unit including the fixing upper-roller 31, the pressurizing roller 32, the fixing belt 33, and the fixing lower-roller 34, in the paper width direction by the fixing unit oscillation motor 36 as a fixing unit drive section. In addition, in some types of the fixing device 30, it is enough that at least the pair of fixing members constituting the fixing nip portion are oscillated by the fixing unit oscillation motor 36.

In this fixing device 30, the paper P is being conveyed with the fixing surface being faced the fixing belt 33, and the paper P passes through the fixing nip portion when the paper P is being conveyed. In this step, the toner image is fixed on the fixing surface of the paper P is performed by the pressurization of the pair of fixing members (a fixing belt 33 and fixing lower-roller 34 in the embodiment) forming the fixing nip portion and by the action of the heat held in one of the fixing members (a fixing belt 33 in the embodiment).

The paper P on which the fixing process is performed by the fixing device 30 is ejected to a paper tray (not shown in the drawing) mounted on the outer side surface of the image forming apparatus 1 by the paper discharge roller 55 or the like. Alternatively, in the case that an image is formed also on the rear surface of the paper P, the paper P on front surface which an image has been formed is conveyed to a reversing roller 56 provided below by a guide member (not shown in the drawing). The conveyed paper P is pinched at its rear end, then the paper P is flipped by being reversely conveyed and ejected to a paper re-feeding path 57 by the reversing roller 56. The paper P is again conveyed to the transfer roller 24 through the paper re-feeding path 57.

FIG. 2 is a block diagram schematically showing a control system of the image forming apparatus 1 according to the embodiment. The control section 10 has a function to totally control the image forming apparatus 1, and as the control section 10 a microcomputer constituted mainly by, for example, a CPU, a ROM, a RAM, and an I/O interface can be used. The control section 10 performs various calculations according to a control program stored in the ROM and controls the operations of the image forming apparatus 1, depending on the calculation results.

The control section 10 forms a toner image on the paper P by performing the following series of steps by controlling each section in the image forming apparatus 1 (for example, the exposure sections 15Y-15K, the charging and developing units 20Y-20K, the fixing device 30, and the like). These are the steps: (1) charging the photoreceptor drams 21Y-21K; (2) forming electrostatic latent images on the photoreceptor drams 21Y-21K with exposure sections 15Y-15K; (3) attaching toner to the formed electrostatic latent images; (4) primarily transferring the toner images on the photoreceptor drams 21Y-21K onto the intermediate transfer belt 23; (5) secondarily transferring the toner images on the intermediate transfer belt 23 on to the paper P; and (6) performing a fixing process on the toner image transferred on the paper P.

The central position of the registration rollers 53 in the paper width direction is generally set to coincide with a standard central position Cst of the apparatus. Further, the paper P is conveyed with the central point in the paper width direction being made to coincided to the standard central position Cst, and image transfer positions, which are start positions of the writing by the exposure section 15Y-15K on the photoreceptor drams 21Y-21K, are set with respect to the conveyance position of the paper P. In a similar way, a central position Cfr of the fixing unit in the paper width direction is set to coincide with a standard central position Cst.

It is one feature of the embodiment that the control section 10 performs a paper oscillation control. In this paper oscillation control, the registration rollers 53 are oscillated by controlling a registration oscillation motor, whereby the conveyance position (a conveyance position of the paper P in the paper width direction) of the paper P is oscillated.

Specifically, the control section 10 holds the paper P having arrived at the registration rollers 53, in the nip portion of the registration rollers 53, and moves the registration rollers 53 and the paper P by a predetermined distance(paper-to-paper basis movement).

In addition, control section 10 changes in advance the image transfer position, which are start positions of the writing, by the exposure sections 15Y-15K, on the photoreceptor drams 21Y-21K, on the basis on such paper-to-paper basis movement, depending on the concerned moving distance.

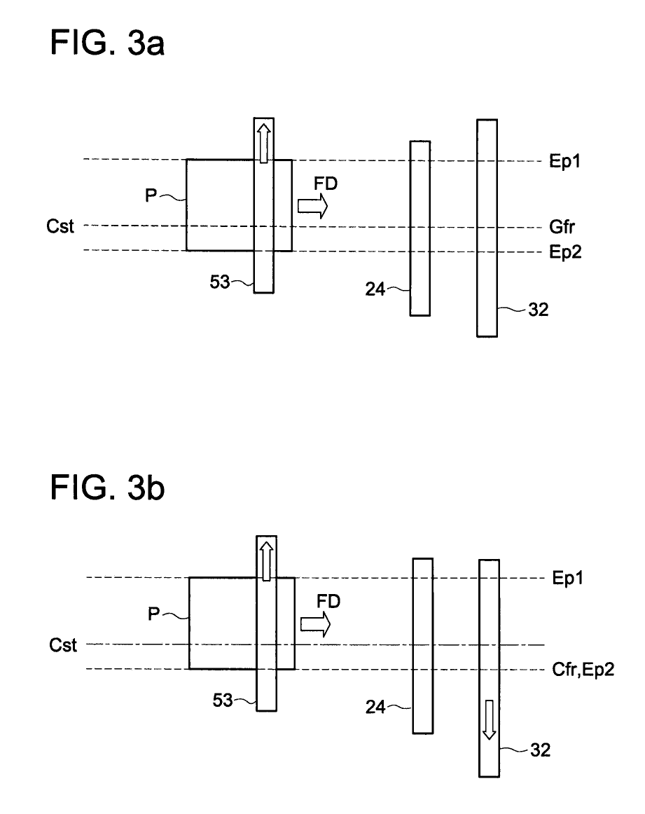

FIG. 3a shows a state that the registration rollers 53 and the paper P have been moved leftward with respect to the traveling direction of the paper P from the standard central position Cst by a predetermined distance. The control section 10 performs the above-described paper-to-paper basis movement every n (n is any natural number) of paper sheets. In addition, by changing the conveyance position of the paper P step by step, the paper P is periodically oscillated about the standard central position Cst.

The control section 10 also performs the fixing unit oscillation control. In the fixing unit oscillation control, the fixing unit is oscillated by controlling the fixing unit oscillation motor 36.

Specifically, the control section 10 moves the fixing unit by a predetermined distance (fixing-to-fixing basis movement) by controlling the fixing unit oscillation motor 36 “between paper sheets”, in other words, after the preceding paper P has passed through the fixing nip portion and before the succeeding paper P reaches the fixing nip portion.

FIG. 3b shows a state that the fixing unit (only the pressurizing roller 32 is shown as an example) is moved rightward in the traveling direction of the paper P by a predetermined distance from the standard central position Cst. The control section 10 performs such fixing-to-fixing basis movement every m (m is any natural number) of paper sheets. In addition, by changing the position of the fixing unit step by step, the fixing unit is periodically oscillated about the standard central position Cst.

As shown in FIG. 3a, by performing the paper oscillation control, the central point of the paper P passes through the position away from the central position Cfr of the fixing unit. In addition, as shown in FIG. 3b, by performing also the fixing unit oscillation control, the positional distance between both sections is secured to be large. In view of the above, the control section 10 according to the embodiment performs the fixing unit oscillation control and the paper oscillation control in correlation with each other, so that the position which is on the fixing members (the fixing belt 33 and the fixing lower-roller 34 in the embodiment) and on which the paper edges Ep1 and Ep2 pass through are totally controlled so as to effectively reduce the deterioration of the fixing members caused by the paper P passing through.

Here, the correlation between the two control methods is particularly embodied satisfying the following conditions: (1) enlarging a range in paper width direction, the range which is on the fixing members and in which the paper edges Ep1 and Ep2 pass through; and (2) reducing spatial nonuniformity and temporal nonuniformity of the passing through tracks which are on the fixing members and on which the paper edges Ep1 and Ep2 pass through.

Here, the spatial nonuniformity means that the passing through tracks are concentrated on the same portion, and the temporal nonuniformity means that the passing through tracks are scattered in a predetermined area but only a small number patterns of the passing through tracks are periodically repeated.

FIG. 4 is a flow chart showing an image forming operation of the image forming apparatus 1 according to the embodiment. The process shown in the flow chart shows the operation with respect to one sheet of paper in chronological order, and when images are formed on a plurality of sheets of paper P in a single job, the process shown in the flow chart is repeated by a predetermined cycle, depending on the number of printings.

In step 10 (S10), the control section 10 monitors the accumulated number of printings, up to the current cycle, of the paper sheets as a printing target (hereinafter, referred to as “print target paper”) by referring to print conditions designated by the user and a history of the printing operation having been performed until the current cycle. Here, the print conditions designated by the user include (a) conditions for image forming such as the selection between single-sided print or both-sided print, intensity and/or magnitude of an image, number of printings, and (b) conditions of paper such as size, type of paper including normal paper or thick paper, and weight of paper.

In step 11 (S11), the control section 10 determines the image transfer position for the print target paper P. The control section 10 previously stores therein a table or a formula defining the relation between the number of printing and the image transfer position which are determined with respect to the correlation between the fixing unit oscillation control and the paper oscillation control. In step 11, the image transfer position is uniquely determined, depending on the number of printings on the print target paper P.

In step 12 (S12), the control section 10 determines the direction of oscillation and the amount of oscillation of the fixing unit. The control section 10 previously stores therein a table or a formula defining the relation among the number of printing, the direction of fixing unit oscillation, and the amount of oscillation which are determined with respect to the correlation of the fixing unit oscillation control and the paper oscillation control. In step 12, the direction of oscillation and the amount of oscillation of the fixing unit are uniquely determined depending on the number of printings on the print target paper P.

In step 13 (S13), the control section 10 feeds the paper P selected by the user by way of the print conditions from the paper supply tray 51. Through this step, the paper P is conveyed from the paper supply tray 51 toward the transfer roller 24.

In step 14 (S14), the control section 10 performs the paper oscillation control. Specifically, the control section 10 holds the paper P having arrived at the registration rollers 53 in the nip portion of the registration rollers 53, and controls the registration oscillation motor 54, based on the image transfer position(start position of image writing) determined in step 11. Through this step, the control section 10 moves the registration rollers 53 and the paper P so that the image transfer position and the conveyance position of the paper P coincide with each other (paper-to-paper basis movement). It should be noted that, the control section 10 controls such that a nipping state of the loop rollers 52 is released during the paper-to-paper basis movement.

In step 15 (S15), the control section 10 restarts the rotation of the registration rollers 53 in synchronism with the toner image formed on the intermediate transfer belt 23, whereby the paper P is fed out toward the transfer roller 24 so that the toner image is transferred onto the paper P. It should be noted that before the toner image is transferred onto the paper P, the control section 10 appropriately changes the start position of image writing by controlling the exposure sections 15Y-15K, based on the image transfer position determined in step 11.

In step 16 (S16), the control section 10 performs the fixing unit oscillation control by using the time between paper sheet which is the time period until the paper P as the print target in the current cycle reaches the fixing nip portion. Specifically, the control section 10 moves the position of the fixing unit by controlling the fixing unit oscillation motor 36, based on the direction of oscillation and the amount of oscillation of the fixing unit determined in step 12 (fixing-to-fixing basis movement).

In step 17 (S17), the control section 10 performs the fixing of the toner image on the paper P by passing the paper P through the fixing nip portion.

In step 18 (S18), the control section 10 ejects the paper P on which the fixing process has been completed, to the paper tray.

As described above, in the embodiment the registration rollers 53 and the registration oscillation roller 54 are disposed on the upstream side of the fixing nip portion in the conveyance path for the paper P, and have a function for conveying the paper P being conveyed toward the fixing nip portion, in the paper width direction (conveyance position setting section). In addition, the control section 10 performs the paper oscillation control for oscillating the conveyance position of the paper P by controlling the registration rollers 53 and the registration oscillation roller 54, and the fixing unit oscillation control for oscillating the fixing unit by controlling the fixing unit oscillation motor 36, in correlation with each other.

With this configuration, by correlating the paper oscillation control with the fixing unit oscillation control, the positions which are on the fixing members (the fixing belt 33 and the fixing lower-roller 34 in the embodiment) and on which the paper edges Ep1 and Ep2 pass through can be controlled. Thus, even if the ranges of oscillation of the oscillation controls have a restriction, these ranges can be simultaneously appropriately effective, and the positions which are on the fixing members and on which the paper edges Ep1 and Ep2 go through can be set at high degree of freedom. With this arrangement, the deterioration of the fixing members caused by the paper P passing through can be effectively reduced.

In addition, in the embodiment, the control section 10 performs the paper oscillation control and the fixing unit oscillation control in correlation with each other so that the ranges in the paper width direction, the ranges which are on the fixing members and in which the paper edges Ep1 and Ep2 pass through are enlarged.

With this configuration, the area which is on the fixing members and in which the paper edges Ep1 and Ep2 can pass through can be largely extended. With this arrangement, the passing positions of the paper edges Ep1 and Ep2 can be arbitrarily set to be a broad area. With such setting, the deterioration of the fixing members caused by the paper P passing through can be effectively reduces.

In addition, in the embodiment, the control section 10 performs the paper oscillation control and the fixing unit oscillation control in correlation with each other so that the spatial nonuniformity and the temporal nonuniformity of the passing through tracks which are on the fixing members and on which the paper edges Ep1 and Ep2 pass through.

With this configuration, by reducing the spatial nonuniformity of the passing through tracks, the situation that the passing through tracks are concentrated on the same portion can be reduced. In addition, by reducing the temporal nonuniformity of the passing through tracks, the passing through tracks can be realized in a large number of patterns, whereby the situation that only a small number of patterns frequently appear can be reduced. With this arrangement, the deterioration of the fixing members caused by the paper P passing through can be effectively reduced.

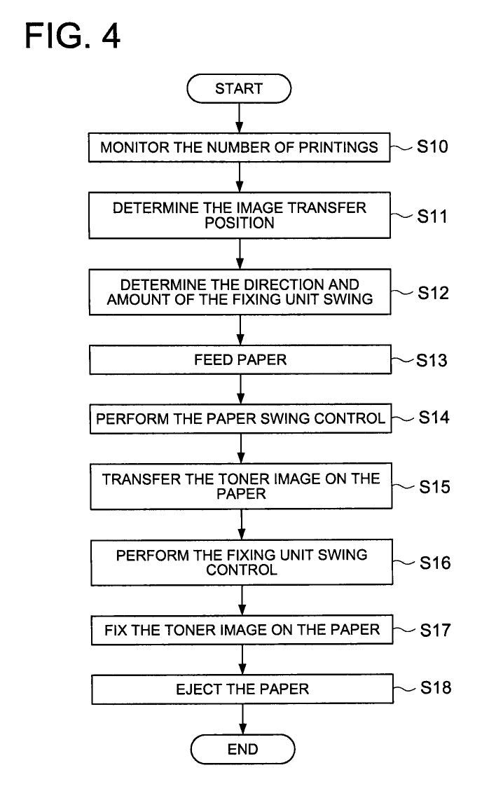

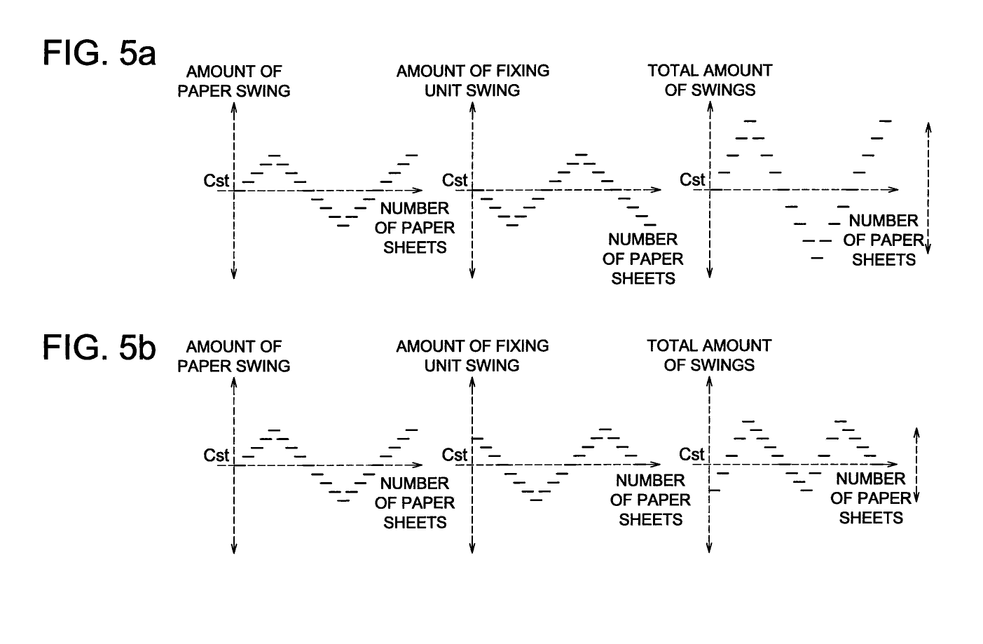

With reference to FIGS. 5a and 5b, a specific example of the method for correlating the paper oscillation control with the fixing unit oscillation control is described below. The amount of paper oscillation shown in the drawing illustrates the oscillation direction and the amount of oscillation of the central position of the paper P (registration rollers 53) with respect to the standard central position Cst, and the amount of oscillation of the fixing unit illustrates the oscillation direction and the amount of oscillation of the fixing unit central position Cfr with respect to the standard central position Cst. In addition, the total amount of oscillation illustrates the oscillation direction and the amount of oscillation of the central position of the paper P with respect to the central position Cfr of the fixing unit.

FIG. 5a is an explanatory diagram showing a state of oscillation in the case that the paper oscillation control and the fixing unit oscillation control are in correlation with each other. This specific example shows a state in which the paper-to-paper basis movement and the fixing-to-fixing basis movement are performed every one paper sheet, similarly to the above-described flow chart. In addition, the oscillation direction of the paper oscillation and the oscillation direction of the fixing unit oscillation are set opposite to each other, in other words, the oscillation cycles are the same and their phases are shifted by a half cycle. In this case, the center of oscillation of the paper P and the center of oscillation of the fixing unit coincide with each other at the standard central position Cst.

The drawing is simplified for convenience, but there is a time difference between the time of the paper P arriving at the registration rollers 53 and the time of the paper P arriving at the fixing device 30. Thus, in the practical operation, it is preferable that the differences among the time of the paper arriving at each oscillation position are taken into consideration.

FIG. 5b is an explanatory diagram of the case that the paper oscillation control is not correlation with the fixing unit oscillation control, and the drawing shows the state that the paper-to-paper basis movement and the fixing-to-fixing basis movement are performed every one paper sheet similarly to FIG. 5a. In addition, the phases are arbitrarily shifted while the oscillation cycles of the paper oscillation and the fixing unit oscillation are identical.

As is known from the comparison between FIGS. 5a and 5b, a total amount of oscillation is secured to be larger when the paper oscillation control and the fixing unit oscillation control are in correlation with each other than when they are not in correlation. For this reason, by performing the paper oscillation control and the fixing unit oscillation control in correlation with each other, the area which is on the fixing members and on which the paper edges Ep1 and Ep2 can pass through can be broadly enlarged.

It should be noted that although the fixing unit oscillation control is performed between paper sheets in the above embodiment, the fixing unit oscillation may be performed on a real-time basis while the paper P is passing through the fixing nip portion.

In addition, although the paper-to-paper basis movement and the fixing-to-fixing basis movement are performed every one paper sheet in the above embodiment, they may be performed every plural of paper sheets such as 3 sheets or 5 sheets.

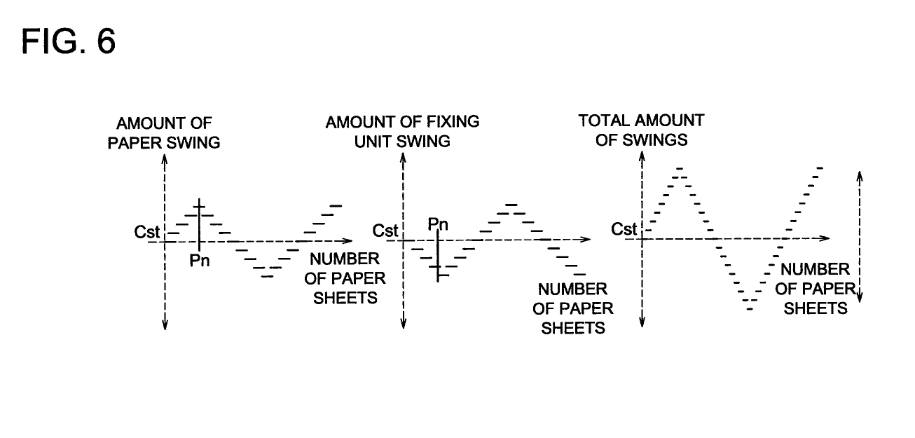

In the following, another specific example is described with reference to FIG. 6 as a method for correlating the paper oscillation control and the fixing unit oscillation control with each other. This specific example shows the state that the paper-to-paper basis movement and the fixing-to-fixing basis movement are performed every two paper sheets, for example. In addition, in the two oscillation controls, the two oscillation cycles are identical and their phases are shifted by a predetermined value (a half cycle+one paper sheet). In this case, the center of oscillation of the paper P and the center of oscillation of the fixing unit coincide with each other at the standard central position Cst.

As above-described, by appropriately setting the phases of the paper oscillation and the fixing unit oscillation, the distribution of the positions which are on the fixing members and on which the papers P (the edges Ep1 and Ep2 of the paper P) pass through can be finely set; thus, the spatial nonuniformity and the temporal nonuniformity of the passing through tracks can be reduced. With this arrangement, the deterioration of the fixing members caused by the paper P passing through can be effectively reduced.

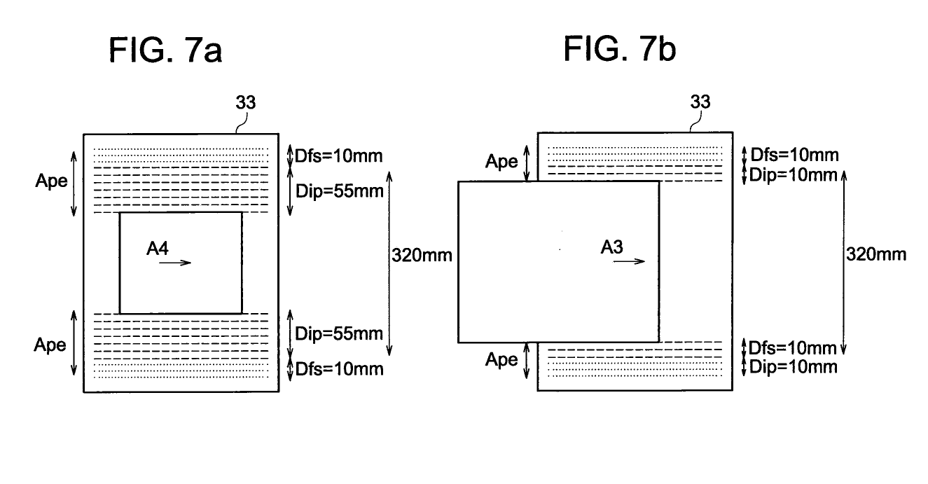

FIGS. 7a and 7b are explanatory diagrams explaining the differences in the amount of oscillation depending on the size of the paper P. FIG. 7a shows an area Ape (edge portion passing range) in which the paper edges Ep1 and Ep2 of small size paper P (A4 size, for example) can pass through, and FIG. 7b shows the paper edge passing range Ape of large size paper P (A3 size, for example). In the drawings, symbol Dfs denotes the amount of oscillation which can be oscillated by the fixing unit oscillation, and symbol Dip denotes the amount of oscillation which can be oscillated by the paper oscillation.

In the case of large size paper P, the amount of oscillation Dip by the paper oscillation is limited to be small (Dip=10 mm, for example) due to an area (effective image area (320 mm, for example)) where an image is effectively formed. In this case, the paper edges Ep1 and Ep2 tend to concentrically pass over the edge portions of the fixing member. To address this issue, the fixing unit oscillation control is used together with the paper oscillation control, and the deterioration of the fixing members is effectively reduced.

In the case of small size paper P, since the paper edges Ep1 and Ep2 pass through an area near the central point of the fixing member, damages tend to occur in an area which is often used as a fixing area Thus, the damages on the fixing members need to be more considered than in the case of the large size paper P. As a result, it is preferable that the amount of oscillation Dip of the paper oscillation is made larger (Dip=55 mm, for example) than that for the large size paper P. Further, in addition to the paper oscillation control, the fixing unit oscillation control can be also used to effectively reduce the deterioration of the fixing member.

Since the control section 10 controls such that the amount of oscillation of the paper oscillation control and the amount of oscillation of the fixing unit oscillation control are varied depending on the size of the paper P in this manner, the deterioration of the fixing members caused by the paper P passing through can be effectively reduced.

### Second Embodiment

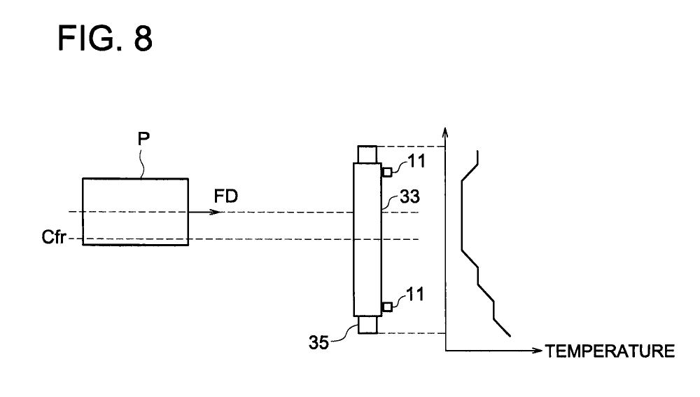

FIG. 8 is an explanatory diagram explaining a concept of the control of the image forming apparatus 1 according to a second embodiment. The image forming apparatus 1 according to the second embodiment is different from that of the first embodiment in that the paper oscillation control is performed depending on the edge temperature of the fixing belt 33. With respect to the configurations that are common to the first and second embodiments, their descriptions are omitted, and only the different points are mainly described below.

In this embodiment, temperature sensors 11 for detecting the temperature of the fixing belt 33 are provided on the respective edge of the fixing belt 33, and detection signals are input to the control section 10 from the temperature sensors 11.

The positions which are on the fixing members and on which the papers P pass through are varied by the fixing unit oscillation control and the paper oscillation control. When the two controls are made to correlate with each other, the passing positions of the paper P on the fixing members are periodically varied; thus, an abnormal temperature region does not occurs often in the fixing belt 33. However, in such a case that after the paper type has been changed from thick paper to thin paper or from large size paper P to small size paper P, and the printing is resumed in the state that the paper P is located on one side region of the fixing member, the temperature on the other side region (abnormal temperature region) of the fixing belt 33 may be raised to a high temperature. In this case, in order to reduce the abnormal temperature, the relative position of the paper P with respect to the fixing belt 33 may be shifted to the abnormal temperature region side, by shifting the paper P.

It should be noted that the oscillation mechanism of the fixing unit is not designed for a high speed or large distance movement thus, in the case of the fixing unit oscillation, it takes a lot of time to move the fixing unit from one side portion to the central portion of the other side portion. For this reason, in the case that the abnormal temperature region have occurred (including the case that the occurrence is expected) in the fixing belt 33, it is difficult to reduce it by the fixing unit oscillation control.

To address this issue, in this embodiment, the abnormal temperature is reduced by the paper oscillation control. Specifically, when the control section 10 has detected the occurrence of the abnormal temperature region in the fixing belt 33, the control section 10 suspends the above-described processing with the fixing unit oscillation control and the paper oscillation control being in correlation with each other, and performs the paper oscillation control so as to reduce the abnormal temperature region. Specifically, when the control section 10 has detected the occurrence of the abnormal temperature on the edge portion through monitoring the edge temperature of the fixing belt 33 with the temperature sensors 11, the control section 10 performs the paper oscillation to move the paper P to the edge portion where the abnormal temperature has occurred.

According to this embodiment, unevenness of the temperature occurred in the fixing members can be effectively reduced. As a result, image quality can be improved.

Further, in the paper oscillation control (the paper oscillation control for reducing the abnormal temperature region) according to the embodiment, not only the fixing unit oscillation control and the paper oscillation control are performed being in correlation with each other, but one of the controls may be performed alone to reduce the unevenness of temperature in the fixing belt 33.

### Third Embodiment

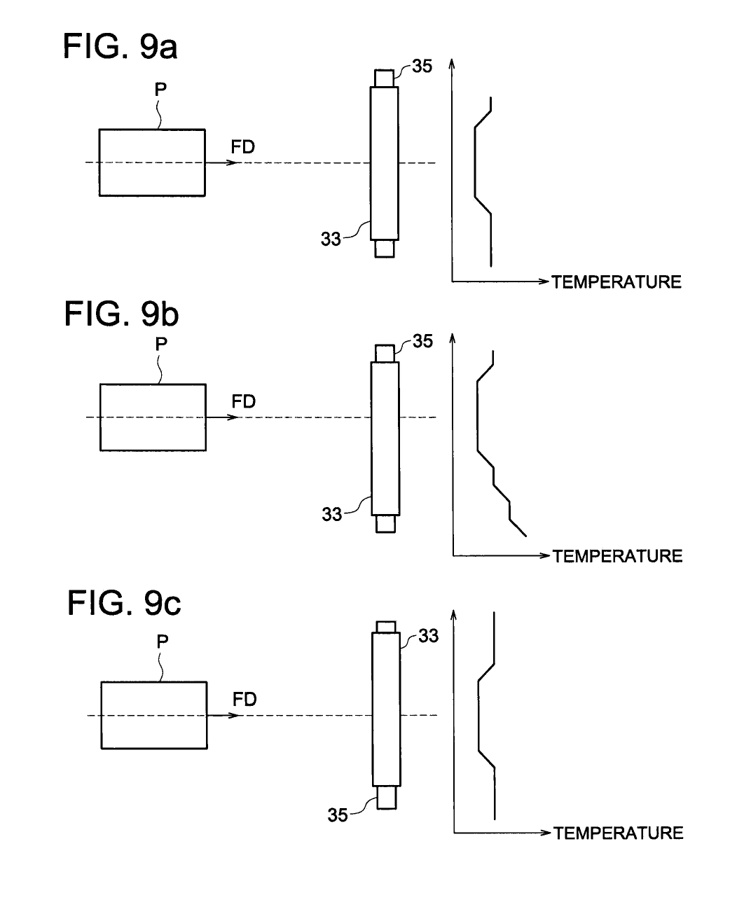

FIGS. 9a, 9b, and 9c are explanatory diagrams explaining a concept of the control of the image forming apparatus 1 according to the third embodiment. The image forming apparatus 1 according to the third embodiment is different from the first embodiment in that unevenness of the temperature in the fixing belt 33 is reduced. With respect to the configurations that are common to the first and third embodiments, their descriptions are omitted, and only the different points are mainly described below.

In this embodiment, a heater 35 for heating for fixing in the fixing device 30 can be oscillated in the paper width direction independently of the fixing member. FIG. 9a shows the situation that the central positions of the fixing belt 33, the paper P, and the heater 35 coincide with each other.

In this situation, when the fixing belt 33 as the fixing members and the heater 35 are oscillated together as shown in FIG. 9b, the papers P passing through enlarge the temperature difference between the edge portions of the fixing belt 33. To address this issue, the control is made to coincide the central point of the paper P and the central point of the heater 35 with each other, whereby a passing range on the heater 35 in which the papers P pass through is constant. Thus, the difference in temperature on the fixing belt 33 can be constant.

As described above, according to the embodiment, the difference in temperature on the fixing belt 33 can be reduced by making the heater 35 controllable independently of the fixing members and by oscillating the heater 35 in coincidence with the conveyance position (central position of the paper P in the paper width direction) of the paper P.

According to the embodiment, the positions which are on the fixing members and on which the paper edge passes through can be totally controlled by correlating the paper oscillation control and the fixing unit oscillation control with each other. As a result, even if the range of oscillations due to the oscillation controls have restrictions, the positions which are on the fixing members and on which the paper edge passes through can be set with a high degree of freedom by appropriately setting the both ranges to be effective. With this arrangement, the deterioration of the fixing members due to the paper passing through can be effectively reduced.

The image forming apparatus according to the embodiment of the present invention was described above; however, it goes without saying that the present invention can be modified in various ways within the scope of the invention without being restricted to the above described embodiments. In the above-described embodiments, the descriptions were made for the single-side printing however, these controls may be applied to the double-side printing. In that case, each of the single-side printing on the opposite sides can be thought as single sheet of paper to apply the above controls. In addition, although in the embodiments, the paper is oscillated by the oscillation of the registration rollers, the paper may be oscillated by the paper-conveying members (conveyance rollers other than the registration rollers) before the paper reaches the transfer member (such as the transfer roller and the intermediate transfer belt) for transferring images, or the paper may be oscillated by a member dedicated for oscillation purpose instead of the conveyance roller before the paper reaches the member for transferring images. In addition, it is enough that the paper is oscillated at least on the upstream side of the fixing nip portion, and the paper does not need to be oscillated on the upstream side of the transfer member.

What is claimed is:

1. An image forming apparatus, comprising:
a fixing unit which has a pair of fixing members pressed against each other to form a fixing nip portion therebetween and is configured to fix an image on paper by passing the paper through the fixing nip portion;
a fixing unit drive section configured to move the fixing unit in a paper width direction which is perpendicular to a conveyance direction of the paper;
a conveyance position setting section which is provided in a paper conveyance path on an upstream side, in the conveyance direction of the paper, of the fixing nip portion and which is configured to move the paper being conveyed toward the fixing nip portion, in the paper width direction; and
a control section configured to perform a paper oscillation control and a fixing unit oscillation control in correlation with each other, the paper oscillation control in which a position of the paper being conveyed is oscillated in the paper width direction by controlling the conveyance position setting section, and the fixing unit oscillation control in which the fixing unit is oscillated in the paper width direction by controlling the fixing unit drive section.

2. The image forming apparatus of claim 1, wherein the control section controls the paper oscillation control and the fixing unit oscillation control in correlation with each other so as to enlarge passing ranges in the paper width direction, the ranges which are on the fixing members and in which edges, in the paper width direction, of the paper pass through.

3. The image forming apparatus of claim 2, wherein the control section controls the paper oscillation control and the fixing unit oscillation control in correlation with each other so as to reduce a spatial nonuniformity and a temporal nonuniformity of passing through tracks which are on the fixing members and on which the edges, in the paper width direction, of the paper pass through.

4. The image forming apparatus of claim 2, wherein the control section controls such that the paper-conveying member and the fixing unit are oscillated in opposite directions to each other while a center of oscillation of the paper and a center of the oscillation of the fixing unit are coincided with each other.

5. The image forming apparatus of claim 1, wherein the control section controls such that an amount of the oscillation by the paper oscillation control and an amount of oscillation by the fixing unit oscillation control are varied depending on a size of the paper.

6. The image forming apparatus of claim 1, comprising:
a temperature detection section configured to detect surface temperature of the fixing member,
wherein when the control section have determined based on a detection result of the temperature detection section that an abnormal temperature region has been generated on the fixing member, the control section interrupts the control in which the paper oscillation control and the fixing unit oscillation control are in correlation with each other, and controls the conveyance position setting section so as to move the paper toward the abnormal temperature region.

7. An image forming apparatus, comprising:
a fixing unit, the fixing unit having:
a pair of fixing members pressed against each other to form a fixing nip portion therebetween; and
a heating section configured to heat the fixing members,
wherein the fixing unit fixes an image on paper by passing the paper through the fixing nip portion;
a fixing unit drive section configured to move the fixing unit in a paper width direction which is perpendicular to a conveyance direction of the paper;
a conveyance position setting section which is provided in a paper conveyance path on an upstream side, in the conveyance direction of the paper, of the fixing nip portion and which is configured to move the paper being conveyed toward the fixing nip portion, in the paper width direction;
a temperature detection section configured to detect surface temperature of the fixing member; and
a control section configured, when the control section has determined based on a detection result of the temperature detection section that an abnormal temperature region has been generated on the fixing member, to control the conveyance position setting section so as to move the paper toward the abnormal temperature region.
